(19) United States
(12) Patent Application Publication
(10) Pub. No.: US 2002/0141207 A1
(43) Pub. Date: Oct. 3, 2002

(54) Current control circuit

(75) Inventor: Henricus Antonius Van Den Braken, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/101,935

(22) Filed: Mar. 20, 2002

(30) Foreign Application Priority Data
Mar. 28, 2001 (EP) 01201148.2

(51) Int. Cl. H02J 3/00

(52) U.S. Cl. 363/34

(57) ABSTRACT

This invention relates to a current control circuit for use as a load circuit for a lamp, such as a gas discharge lamp. The current control circuit comprises two or more capacitors connected in series with each other and with said lamp.

The invention also relates to a high voltage generator circuit for driving one or more lamps, such as gas discharge lamps. The high voltage generator circuit comprises a rectifier circuit for converting alternating current from a power supply line to direct current, said direct current being supplied to a rectifier output. It also comprises an inverter connected to the rectifier output, having an inverter output for parallel connection to one or several lamps. The inverter converts the direct current to a high frequency alternating current which is supplied to the inverter output. Each of said lamps is further connected in series with a current control circuit that comprises two or more capacitors connected in series with each other and with the respective lamp.

This invention relates to a current control circuit for use as a load circuit for a lamp, such as a gas discharge lamp. The invention also relates to a high voltage generator circuit for driving one or more lamps.

In many applications there is a need for high voltage generator circuits for driving multiple lamps, such as gas discharge lamps. One example of such applications relates to the manufacture of backlighting panels for LCD displays.

A high voltage generator circuit usually comprises an AC-DC converter (rectifier) to change an alternating current from a power network or an AC source to a direct current. The direct current is subsequently supplied to an inverter circuit (DC-AC converter), in which it is changed back to an alternating current having a much higher frequency than the above-mentioned alternating current from the power network. The output of the inverter circuit is connected to a plurality of lamps which are connected in series and or in parallel. Consequently, a plurality of lamp branches, each comprising one or more lamps, is connected in parallel with the output of the inverter circuit. The above-described high voltage generator circuit acts like a voltage source during ignition of the lamps connected to the circuit, and, in the burning mode, (i.e. when the lamps are conducting) the lamp branches act as current sources in order to have only a slight variation in light output.

Gas discharge lamps constitute non-linear loads on an electric power line. When a voltage is applied across a gas discharge lamp, there will be no current flow through the lamp, until a certain ignition/kick-off voltage is reached. At this point the lamp becomes conducting. Thereafter the current through the lamp will increase rapidly. A current control circuit is often connected in series with each lamp to limit the current. The current control circuit is intended to control the current through each lamp and thereby prevent overloading.

Usually, the above-described current control circuit comprises a single capacitor. A capacitor does not only provide for current control, but also for a constant current through the lamp. A construction with a single capacitor current control circuit is shown in for example patent document U.S. Pat. No. 5,781,418. Here, a load capacitor, or ballasting capacitor, is connected in series with a fluorescent lamp, together forming a lamp branch. A plurality of lamp branches is connected in parallel to the output of a transformer.

However, a problem with the above-described current control circuits is that, during the ignition state of the lamps, the voltage across each lamp branch is very high. In the event of a fault condition, such as a shorted capacitor, there will be a large current flowing through the lamp branch with the defect capacitor. Consequently, this may be hazardous to a user.

Therefore, it is an object of this invention to obtain a current control circuit providing a safer and improved limitation of the current through each lamp. A further object of the invention is to provide a current control circuit that further stabilizes the lamp current.

The above-mentioned object, and other objects, are achieved in accordance with the invention by a current control circuit for use as a load circuit for a lamp, such as a gas discharge lamp, characterized in that said current control circuit comprises two or more capacitors connected in series with each other and with said lamp. By using a plurality of capacitors connected in series instead of a single capacitor, failure of one single component, such as a short circuit, will not result in a high current through the lamp. In accordance with a preferred embodiment said capacitors are of equal capacitance, resulting in an even distribution of currents through the components.

The objects of the invention are also achieved by a high voltage generator circuit for driving one or more lamps, such as gas discharge lamps, wherein said high voltage generator circuit comprises a rectifier circuit for converting alternating current from a power supply line to a direct current, said direct current being supplied to a rectifier output, and an inverter connected to said rectifier output, having an inverter output for parallel connection to one or several lamps, said inverter converting said direct current to a high frequency alternating current supplied to said inverter output, whereby each of said lamps is connected in series with a current control circuit, said high voltage generator circuit being characterized in that said current control circuit comprises two or more capacitors connected in series with each other and with the respective lamp. As mentioned above, by using a plurality of capacitors connected in series instead of a single capacitor, the failure of one single component, such as a short circuit, will not result in a high voltage through the lamp. Furthermore, according to a preferred embodiment said capacitors in said current control circuit are of equal capacitance, resulting in an equal distribution of voltage across the capacitors.

The invention will be apparent from and elucidated with reference to the embodiment(s) and other aspects of the described hereinafter.

In the drawings:

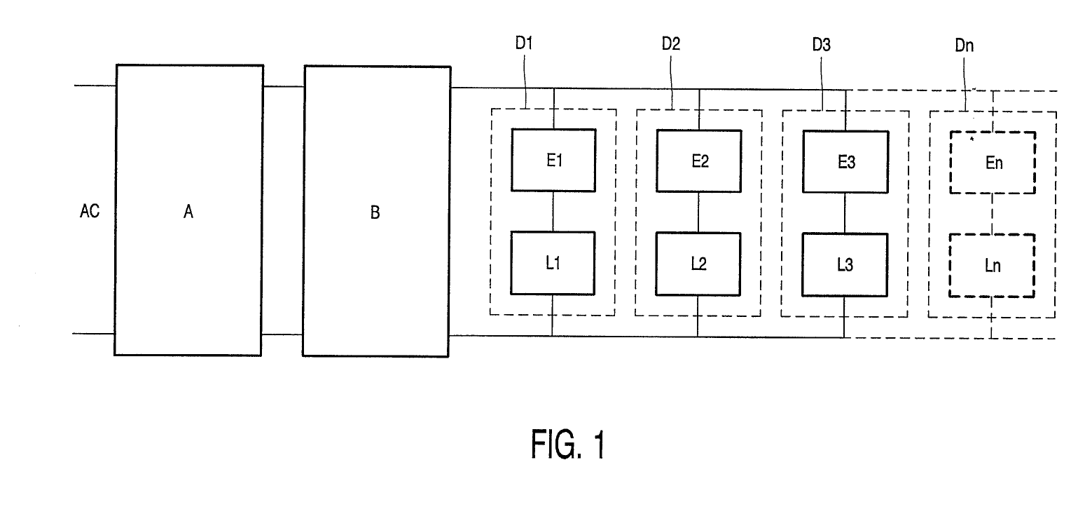

FIG. 1 is a schematic view of a high voltage generator circuit for driving multiple lamps.

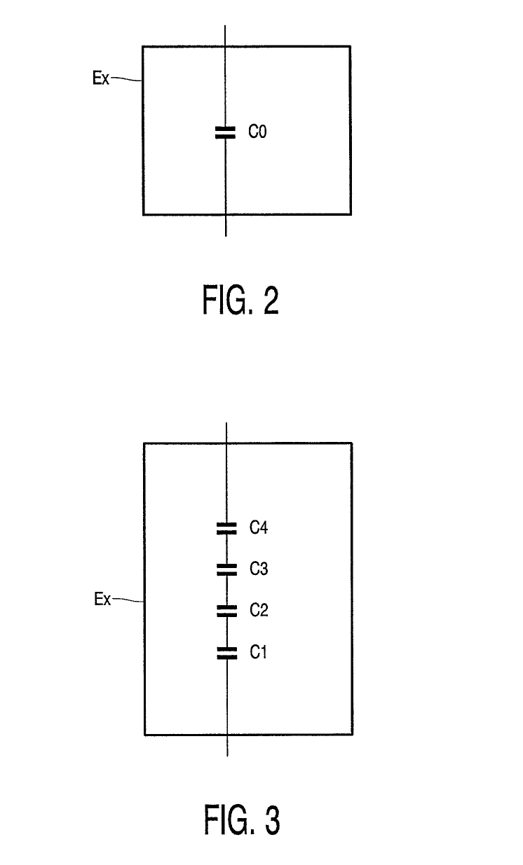

FIG. 2 shows a current control circuit in accordance with the prior art.

FIG. 3 shows a current control circuit in accordance with the invention.

FIG. 1 shows the basic components of an electric high voltage generator circuit for a plurality of gas discharge lamps, as known from the prior art. The high voltage generator circuit comprises a rectifier circuit A and an inverter circuit B. Both these circuits may be constructed and designed in a plurality of ways, as described in the prior art, and they will not be described in greater detail herein, since they are not of primary importance to the invention. Furthermore, a plurality of gas discharge lamp circuits D1, D2, . . . Dn, each comprising at least one lamp L1, L2, . . . Ln, and a current control circuit E1, E2, . . . En connected in series with said lamps, are connected in parallel with the inverter circuit. In prior art circuits, the above mentioned current control circuit consists of a single capacitor Co as shown in FIG. 2.

FIG. 3 shows a current control circuit Ex in accordance with the invention. Here, the above-described current control circuit comprises a plurality of capacitors, as shown in FIG. 3 four capacitors C1, C2, C3, C4, connected in series with each other. By substituting the single capacitor in the prior art with a plurality of capacitors connected in series with each other, the risk of high currents through the lamp as a result of a shorted capacitor is greatly reduced.

The high voltage generator circuit as described above can be applied, inter alia, for backlighting in an LCD display or the like. A high voltage generator circuit of the above-described kind, for driving multiple lamps, first acts as a voltage source during the ignition of the lamps. Thereafter, during the burning mode, each lamp branch, that comprises a lamp and a current control circuit, acts as a current source in order to provide a light output having only slight variations. In the high voltage generator circuit for backlighting, preferably, a half-bridge LLCC circuit is included in a manner which is known per se, but other power topology circuits are possible, since this is not of primary importance to the invention, it is not disclosed herein.

It is to be noted that even if the invention is described in connection with gas discharge lamps, it may also be used for driving other kinds of fluorescent lamps that require a large ignition/kick-off voltage. Furthermore, the above-described high voltage generator circuit may have a large variety of designs. It may for example be designed to be connected to a DC-source, in which case the rectifier may be eliminated. It will also be understood that the number of capacitors of the above current control circuit may be changed in order to apt the circuit to economic or safety requirements.

1. A current control circuit for use as a load circuit (Ex) for a lamp, such as a gas discharge lamp (Lx), characterized in that said current control circuit (Ex) comprises two or more capacitors (Cx) connected in series with each other and with said lamp (Lx).

2. A current control circuit (Ex) in accordance with claim 1, wherein said capacitors (Cx) are of equal capacitance.

3. A high voltage generator circuit for driving one or more lamps, such as gas discharge lamps (Lx), said high voltage generator circuit comprising:
rectifier circuit (A) for converting alternating current from a power supply line to direct current, said direct current being supplied to a rectifier output, and
an inverter (B) connected to said rectifier output, having an inverter output for parallel connection to one or several lamps (Lx), said inverter (B) converting said direct current to a high frequency alternating current which is supplied to said inverter output, whereby each of said lamps (Lx) are connected in series with a current control circuit (Ex), said high voltage generator circuit being characterized in that said current control circuit (Ex) comprises two or more capacitors (Cx) connected in series with each other and with the respective lamp (Lx).

4. A high voltage generator circuit in accordance with claim 3, wherein said capacitors (Cx) in said current control circuit (Ex) are of equal capacitance.
